(19) United States
(12) Patent Application Publication
(10) Pub. No.: US 2018/0357479 A1
(43) Pub. Date: Dec. 13, 2018

(54) BODY-WORN SYSTEM PROVIDING CONTEXTUAL, AUDIO-BASED TASK ASSISTANCE

(71) Applicant: Microsoft Technology Licensing, LLC, Redmond, WA (US)

(72) Inventors: Manohar Swaminathan, Bangalore (IN); Abhay Kumar Agarwal, San Francisco, CA (US); Sujeath Pareddy, Hyd (IN)

(21) Appl. No.: 15/617,817

(22) Filed: Jun. 8, 2017

(51) Int. Cl. G06K 9/00; G06K 9/32; G10L 13/04; G10L 15/22; H04N 7/18; G09B 21/00

(52) U.S. Cl. CPC G06K 9/00671; G06K 9/00355; G06K 9/3258; G10L 13/043; G10L 2015/223; H04N 7/185; G09B 21/006; G06K 2209/01; G06K 2209/17; G10L 15/22

(57) ABSTRACT

An apparatus and method for audibly identifying an object indicated by a hand includes an electronic imager and an audio device. A processing system coupled to the imager and the audio device is configured to cause the imager to capture an image including the hand and the object. The processing system is also configured to process the captured image to identify and track the hand to identify the object indicated by the hand, to contextual assistance data with respect to the indicated object, to generate audio data describing the contextual assistance data, and to provide the generated audio data to the audio device.

### BACKGROUND

Visually impaired persons (VIPs) often rely on their sense of touch to identify everyday objects. Due to the nature of modern packaging and the lack of accessible tactile markings, however, the identity of many such objects is ambiguous. To a VIP, a box of cookies may be indistinguishable from a box of toothpaste; a Granny Smith apple may be indistinguishable from a McIntosh apple. These problems are exacerbated by the industrial design of mass-manufactured goods, which place different goods in similar paper or plastic packaging.

### SUMMARY

This summary is not an extensive overview of the claimed subject matter. It is intended to neither identify key elements of the claimed subject matter nor delineate the scope of the claimed subject matter. Its sole purpose is to present some concepts of the claimed subject matter in a simplified form as a prelude to the more detailed description that is presented later.

An apparatus and method for audibly providing contextual assistance with objects indicated by a user's hand includes an electronic imager and an audio device. A processing system coupled to the imager and the audio device is configured to cause the imager to capture an image of the hand and the indicated object. The processing system is also configured to process the captured image to identify and track the hand and the object. The processing system is further configured to process the image to provide contextual assistance concerning the object by generating audio data concerning the object and providing the generated audio data to the audio device.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description when considered in conjunction with the drawings.

### BRIEF DESCRIPTION OF THE DRAWINGS

FIG. 1A and 1B are front and side-plan views of an example task assistance system;

FIGS. 2A and 2B are side and front-plan drawings showing a user wearing an example contextual, audio-based task assistance system;

FIG. 3 is an image diagram showing an image produced by an example task assistance system;

FIG. 4 is a is a block diagram of an example system including a task assistance system, an artificial intelligence provider and a crowd-source provider;

FIG. 5 is a functional block diagram of an example task assistance system;

FIG. 6 is a flow diagram that is useful for describing the operation of the example task assistance system;

FIG. 7 is a flow-chart showing the operation of an example task assistance system.

### DETAILED DESCRIPTION

As a preliminary matter, some of the figures describe concepts in the context of one or more structural components, variously referred to as functionality, modules, features, elements, or the like. The various components shown in the figures can be implemented in any manner, such as software, hardware, firmware, or combinations thereof. In some cases, various components shown in the figures may reflect the use of corresponding components in an actual implementation. In other cases, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into multiple component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include microprocessors, digital signal processors (DSPs), microcontrollers, computer systems, discrete logic components, and/or custom logic components such as field programmable gate arrays (FPGAs), application specific integrated circuits (ASICs), programmable logic arrays (PLAs) or the like.

As to terminology, the phrase “configured to” encompasses any way that any kind of functionality can be constructed to perform an identified operation. The functionality can be configured to perform an operation using, for example, software, hardware, firmware, or the like. For example, the phrase “configured to” can refer to a logic circuit structure of a hardware element that is arranged to implement the associated functionality. The phrase “configured to” can also refer to a logic circuit structure of a hardware element that is arranged to implement the coding design of associated functionality of firmware or software. The term “module” refers to a structural element that can be implemented using any suitable hardware (e.g., a processor, among others), software (e.g., an application, among others), firmware, and/or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any non-transitory computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

The following describes apparatus and methods for assisting a visually impaired person or other person who cannot readily identify objects or read text associated with the objects. The apparatus and method use a tactile/gesture directed computational task assistance system, worn by the user in a way that allows free motion of both hands. The task assistance system may help the user to discern details of physical objects. The example task assistance system uses computer vision and, optionally, an artificial intelligence (AI) system and/or a crowd-sourced human assistance system to provide contextual assistance regarding one or more objects indicated by a user's hands. The contextual assistance may be, for example, a short audio description of an object received automatically during the course of a user's normal tactile interactions with the object. The task assistance system may provide some information about the physical objects with near-instantaneous feedback and may request additional information about the object in response to audible or gestural inquiries. The task assistance system may, however, provide the additional information with greater latency. The example task assistance system responds to gestural commands and uses tactile movement and/or manipulation to infer properties of and provide assistive information for objects associated with a user's hands while the user engages in normal tactile interactions with the objects.

Although the examples described below concern identifying features of an object, such as its color, shape and any text that may be on or near the object, it is contemplated that the system may provide other types of contextual assistance. For example, a VIP may approach a vending machine and ask “What types of candy bars are in this vending machine?” In response, the crowdsource system may ask the VIP to move closer or farther away and/or to redirect the camera to obtain a better image and send the new image to the crowdsource system asking the same question. The crowdsource system may then respond with a list of the available candy bars. The VIP may then ask “how do I get a chocolate bar?” The crowdsource system may then direct the VIP to make an appropriate payment and to press an appropriate button by sending a message such as “insert one dollar in the coin slot on the upper right side of the machine next to the glass and push the button in the third row and fourth column of the buttons located below the coin slot.” The VIP may then locate the coin slot and buttons using touch to complete the task. Similarly, a user who wants to enter a building may, in response to a query, be prompted to find the door handle, turn it clockwise, and push based on an interpretation of an image of the door by provided by the crowdsource system or the AI system.

The task assistance system may improve upon existing solutions for object recognition in several ways: it may merge both computational and human-labeled information into a single interaction, it may create a simplified experience where existing user habits, such as tactile manipulation with both hands, do not have to change significantly, and it may have a form-factor tailored for use by VIPs. The example task assistance systems described below employ computer vision to augment a user's sense of touch. The system improves upon other visual assistance systems by using gestures and tactile actions to direct computational resources to extract descriptions of objects indicated by the user's hand or hands. VIPs using the system do not need to modify their current habits of using their sense of touch to discern properties of objects.

Although the examples below describe a system used by VIPs, it is contemplated that many aspects of the system may also be useful to sighted individuals. For example, a person who cannot read or who does not know the local language may use a device similar to the task assistance system 110 to read and translate labels on cans and boxes while shopping. When the user wants text translated, the task assistance system described below may be adapted for these uses by including either a local machine translation module (not shown), by invoking a machine translation service, such as Microsoft Translator, and/or by sending captured images to a crowdsource translation service.

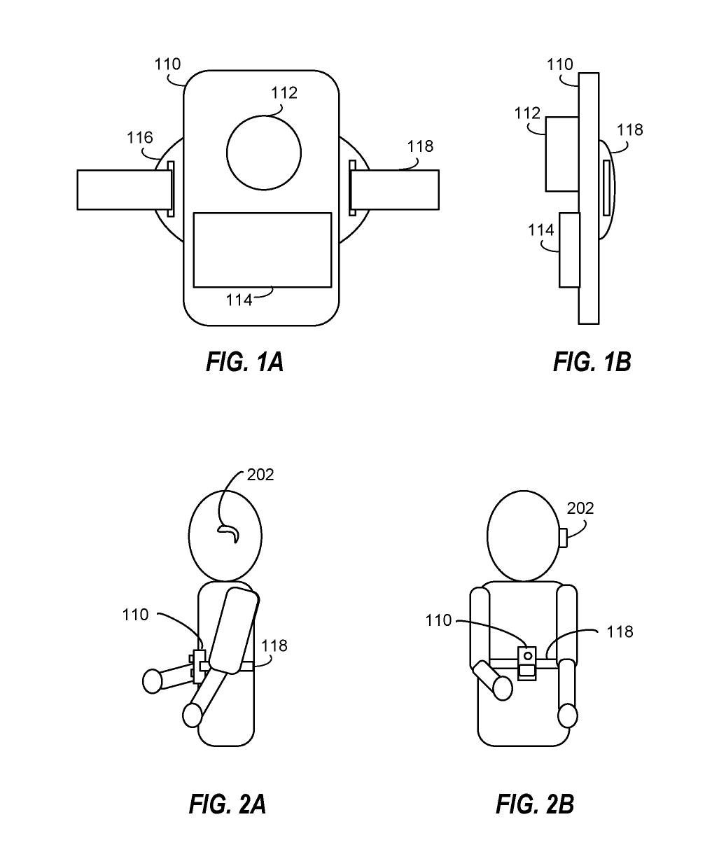

As shown in FIG. 1A, an example task assistance system 110 includes a shallow depth-of-field (DOF) camera 112, a hand tracker 114 and a wireless short-range communication earpiece (shown as item 202 in FIGS. 2A and 2B). The example task assistance system 110 includes a housing 111 that may hold computational resources, such as a processor, memory, and a power supply that may be used to implement the functions described below. Alternatively, the system may employ other computational resources, for example, a smart phone or a personal computing device worn in a backpack and connected to the task assistance system 110 either by a wired connection or a wireless connection.

The shallow DOF camera 112 may be, for example, a Life Cam Studio® camera available from Microsoft Corp. The example camera 112 includes an electronic imager, such as an active pixel sensor (APS) imager or a charge-coupled device (CCD) imager. The example camera includes optical elements that, under normal indoor lighting, provide a DOF between 10 centimeters and 2 meters. The camera provides individual image frames or video frames at a frame rate (e.g. 30 frames per second).

The hand tracker 114 may be, for example, a Leap Motion® hand tracking sensor system available from Leap Motion Inc. The hand tracking 114 system includes an infrared (IR) emitter and stereoscopic cameras, each having an IR imager. In addition to capturing images, the example hand tracking system 114 identifies hands in the image and provides data indicating the pose of the hand in space.

The housing 111 for the example task assistance system 110 is coupled to a mounting piece 116 having the form factor of a belt buckle. A belt 118 is threaded through the mounting piece 116 so that the task assistance system 110 may be worn in a position that allows the VIP to easily hold objects in the field of view of the system 110.

FIGS. 2A and 2B show an example of how a VIP may use the task assistance system 110. As shown, the VIP wears task assistance system 110 on a belt 118 at a location on the VIPs body that allows the VIP to hold, touch or point to an object in the field of view of the camera 112 and/or the hand tracking system 114 to indicate the object for which contextual assistance is needed. In the examples described below, the field of view of the hand tracking system overlaps or complements the field of view of the camera. It is contemplated that the belt may include an elastic strap configured to allow the user to move the task assistance system up or down on the user's chest. This configuration allows the user to place the task assistance system 110 in a position that captures the user's normal tactile interaction with objects and visual features of the user's environment. For example, a seated user seated at a table may position the example task assistance system relatively high on the chest to obtain visual assistance while pointing to or manipulating objects on the table. Alternatively, a standing user may position the task assistance system lower on the body, for example, at elbow level, to obtain visual assistance during tactile interactions with the user's environment (e.g. holding a package while shopping or touching or pointing to a sign). In one embodiment, the user may wear two belts, one high on the chest and another at waist level with the task assistance system being configured to be positioned along a vertical strap connecting the two belts. Other methods and apparatus may be used to allow users to adjust the position of the task assistance systems 110 to have a view of the users' hands while allowing the users to interact with their environment using both hands.

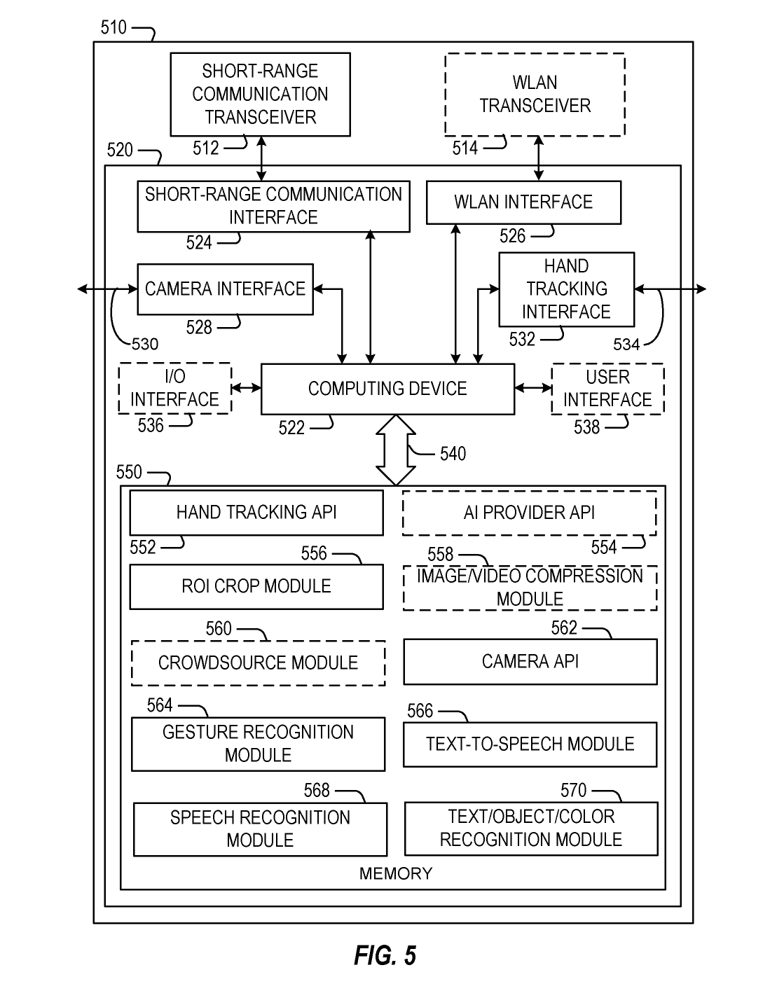

As described below with reference to FIG. 5, the example task assistance system 110 includes a short range transceiver, for example, a Bluetooth or Bluetooth low energy (BLE) transceiver through which the example task assistance system 110 sends audio data to and receives audio commands from the VIP via a short-range communications earpiece 202. While the system is described below as using a Bluetooth transceiver, it is contemplated that other short range transceivers may be used, for example, IEEE 802.15 (ZigBee), IEEE 802.11 Wi-Fi, or a near field communication (NFC) system. Alternatively, the short-range transceiver may include an optical device, for example an infrared (IR) transceiver or an ultrasonic transceiver. It is also contemplated that a task assistance system 110 may employ a wired earphone/microphone combination in place of the short range transceiver and short-range communications earpiece 202.

The example task assistance system 110 uses a belt buckle form-factor. This form factor may be advantageous due to its ability to withstand shakes and jerks, and because it generally allows a clear view of the user's grasping region while allowing the users to use both hands to interact with the objects and visual features in their environments. Furthermore, the form factor allows the device to be always on so that the user does not need to remember to turn on the task assistance system 110 before using it.

This form-factor may improve on a head-mounted design since VIP users who may not be accustomed to looking at objects do not need to use their gaze to orient the camera. The belt form factor allows the VIP to re-position the device to sit higher or lower on their body at a position that is most effective for the way they examine objects. The examples below describe the VIP holding an object and the example task assistance system 110 tracking the hand in order to identify the object. If the object is sufficiently large, then the belt camera may not be able to detect the hands as they will be outstretched or otherwise obscured. In these cases, the VIP may be able to use verbal commands or a gestural command such as pointing toward the object or touching the object to request assistance from the task assistance system 110.

Although the examples below describe a belt mounted form factor it is contemplated that task assistance system 110 may be implemented using, an HMD or a pendant. Alternatively, the system 110 may be temporarily attached to an article of clothing, for example, held in a pouch having an opening for the camera 112 and hand tracking system 114.

The example task assistance system 110 combines a stereoscopic IR sensor for gesture detection and a webcam with fixed, shallow DOF. The DOF places a volume directly in front of the user in focus while naturally blurring objects more distant from the user. As described below, this feature of the camera may make it easier to identify and capture features of the object (e.g. text). While the examples described below employ a specialized hand-tracking system, it is contemplated that the functions of the gesture recognition system and the camera may be combined, for example, by using stereoscopic image sensors and a neural network trained to perform spatial gesture recognition. The images used for the spatial gesture recognition may then be used by the object recognition system.

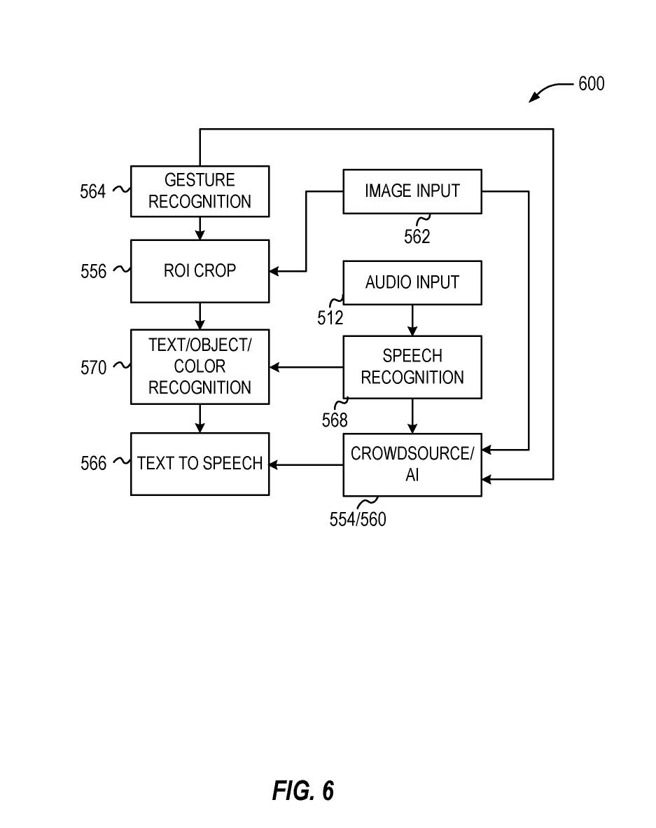

The example software described below may be implemented as an asynchronous multithreaded application in a computing language such as Python using OpenCV. Gestures, speech, and camera frames can be received from the sensors triggering cascading dependent tasks in parallel. A schematic of an example processing pipeline is described below with reference to FIG. 6.

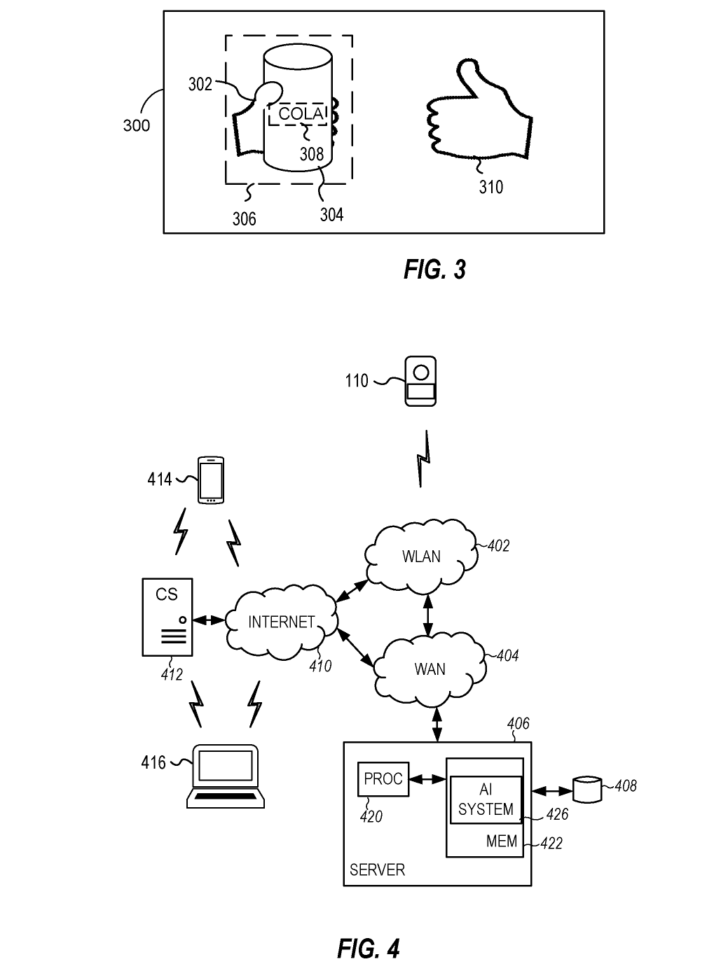

FIG. 3 shows an example image 300 that may be captured by the task assistance system 110. This image may be captured in a retail store in which the user wants contextual assistance regarding a held object, in this case a can of cola. In this image, the example hand tracking system 114 has identified the hands 302 and 310 in the image with the hand 302 in a grasping position. Using this information, the task assistance system 110 captures the image provided by the narrow DOF camera 112 and the gesture (thumbs-up) indicated by the hand 310, as captured by the example hand tracking system 114. As described in more detail below, one thread of the processing may crop the image 300 to provide an image 306 that includes the object 304. The processor may then analyze the cropped image to identify areas that may correspond to text (e.g. areas having relatively high spatial frequency components). These areas, such as the area 308, may then be provided to an optical character recognition (OCR) system to recognize the textual elements (e.g. the word “COLA”). The text elements may then be converted to speech and provided to the user via the earpiece 202.

Another thread of the processing may recognize the gesture of the right hand 310 and pass the entire image 300 or the cropped image 306 of the left hand to a remote artificial intelligence system and/or a crowdsource recognition system through a wireless local area network (WLAN). As described above, these systems may have greater latency than the onboard text recognition system but may be able to provide the VIP with more information about the held object.

FIG. 4 is a block diagram of an example system 400 showing an example task assistance system 110, AI system 406, and crowdsource system 412. The VIP may communicate with the AI system 406 and/or crowdsource system 412 through the WLAN 402 and/or the WAN 404. The WAN 404 may be an enterprise WAN of the AI provider or it may be the Internet. When the WAN 404 is an enterprise WAN (e.g. a commercial Wi-Fi network), it may be connected to the Internet 410. The crowdsource system 412 may be implemented in a server to which the VIP connects via the WLAN 402 and the Internet 410. When the WAN 404 is the Internet, the connections to the Internet 410 shown in FIG. 4 may, instead, connect to the WAN 404. As shown in FIG. 4, the WLAN 402 may connect to the Internet 410 directly or through the WAN 204.

The crowdsource provider system 412 may, for example, include a crowdsource identification system such as Crowdsource®, Amazon Mechanical Turk® (AMT), or CloudSight®. When crowdsource system 412 receives a request for contextual assistance, in this case, to identify a target image, such as the image 300 or the cropped image 306, shown in FIG. 3, the system 412 sends the target image to one or more persons using personal computing devices such as a devices 414 and 416, shown in FIG. 4. The person receiving the image may also receive text indicating the meaning of the gesture or text or audio of the question asked by the user of the task assistance system 110. As described below, the user may ask the crowdsource service to identify the object, to read any writing on the object, and/or to tell the user other characteristics of the product such as its color. The person operating the device 414 or 416 may then respond with a short text message. This message may be conveyed to the task assistance system 110 through the Internet 412 or WAN 404 to the WLAN 402. As shown in FIG. 4, the devices 414 and/or 416 may be coupled to the crowdsource provider 412 either via a local WLAN (not shown) or via the Internet 412.

As shown in FIG. 4, in one implementation, the AI provider system 406 includes a processor 420 and a memory 422. The system 406 may also include a network interface, an input/output interface (I/O), and a user interface (UI). For the sake of clarity the UI and I/O elements are not shown in FIG. 4. The memory 422 may include software modules that implement the artificial intelligence system 426. In addition, the memory may hold the software for the operating system (not shown). Although the AI system 424 is shown as a software module of the server 406, it is contemplated that it may be implemented across multiple systems each using separate hardware and/or modules, for example, a database 408, a neural network (not shown) or a classifier (not shown) such as a hidden Markov model (HMM), a Gaussian mixture model (GMM) a and/or a support vector machine (SVM). The AI module may also be implemented on a separate computer system (not shown) that is accessed by the server 406. It is also contemplated that the AI module may be remote from the server 406 and accessed via the WAN 404 and/or Internet 410.

Example AI systems that may be used as the system 406 include Microsoft's Computer Vision Cognitive Services®, Google's Cloud Vision® service, and IBM's Watson® service. Any of these services may be accessed via an application program interface (API) implemented on the task assistance system 110. The example task assistance system 110 uses Microsoft's Computer Vision Cognitive Services, which takes an arbitrary image and returns metadata such as objects detected, text detected, dominant colors, and a caption in natural language. The AI systems may provide a latency (e.g. on the order of 1 to 5 seconds) that is between the latency of the onboard text recognition system and the latency of the crowdsource system.

The example task assistance system 110 may use a crowdsource human aided captioning system such as CloudSight to obtain metadata describing the image 300 or the cropped images 306 and/or 308. the crowdsource system may return a short phrase written by a human worker but with significant latency. Alternatively the crowdsource system operator may reject the image if the cropped 308 image is not suitable for captioning and return a text message describing why the image could not be labeled.

The significant latency difference between the computational labeling performed locally by the task assistance system 110 on the one hand and the AI labeling performed by the AI service 406 and/or the human-powered labeling performed by the crowd sourcing service 412 allows the user to rotate or re-align the object for multiple OCR attempts. Thus, by the time the crowdsourced labeling arrives, the user may have a reasonable idea of at least some specific textual and tactile properties of the object in order to more clearly interpret the general description given by the crowdsource system 416 and perhaps generate follow-up inquiries.

FIG. 5 is a functional block diagram showing details of an example task assistance system 110. The example system includes a computing platform 520, a memory 550 a short range communication transceiver 512 and an optional wireless local access network (WLAN) transceiver 514. As described above, the short-range communication transceiver 512, which may be a Bluetooth or BLE or other short-range device receives audio commands from a user and provides contextual descriptions of held objects to the user via the short-range communication earpiece 202, shown in FIG. 2. The example task assistance system 110 uses the WLAN transceiver 514 to access the AI service 406 and crowdsource service at 412 via the WLAN 402. Thus the WLAN transceiver 514 is not needed when the task assistance system 110 operates using only the local image capture, cropping, OCR, and object recognition capabilities.

The example computing platform 520 includes a computing device 522 which may be, for example, a multicore microprocessor and may also include other processing elements such as a digital signal processor, a neural network, and/or logic circuitry such as a field programmable gate array (FPGA). The example computing device 522 is coupled to a camera interface 528 which connects to the narrow DOF camera 112 via the connection 530. Similarly, the example device 522 is coupled to a hand tracker interface 532 which is coupled to the hand tracking system 114 via the connection 534.

As described above, the example system 110 is configured to communicate with the user via the short-range communication transceiver. Alternatively, data may be input to and output from the computing device 522 via an optional I/O interface 536. The task assistance system 110 may also be equipped with an optional user interface 536 including a display screen and/or a keypad (not shown), for example, to allow the user or a technician to configure the system 110 (e.g. to associate the system 110 with a local WLAN) as well as to perform simple operations such as turning the system 110 on or off and adjusting the gain of audio signals received from and provided to the earpiece 202.

The example computing device 522 is connected to the memory 550 via a bus 540. The example memory includes modules 556, 564, 566, 568, and 570 that implement the local text and object recognition system, modules 562 and 552 that respectively interface with the camera 112 and hand tracking system 114 as well as modules 554 and 560 that interface with the AI computer vision service 406 and the crowdsource service 412, respectively. Example modules 552, 554, 560, and 562, include application program interfaces (APIs) provided by the respective manufacturers/service providers.

The example region of interest (ROI) Module 556 finds an ROI in an image captured by the camera 112. As described above, the example camera 112 is a narrow DOF device. Camera 112 also may include autofocus capabilities such that it automatically focuses on and object placed in its field of view. Thus, as shown in FIG. 3, the camera, guided by the hand tracking system 114 automatically captures an in-focus image of the hand 302 grasping the cola can 304. Due to the narrow DOF, the can is in focus but the background is blurred. The ROI module 556, processes the image to identify an area likely to have textual features. This may be done, for example, using a Extremal-Regions Text Detection classifier such as is described in an article by L. Newman et al. entitled “Real-Time Scene Text Localization and Recognition” Computer Vision and Pattern Recognition (CVPR) 2012 IEEE Conference pp. 3538-3545. It is contemplated that other methods for locating areas of the image likely to have text may include analyzing the image for locations having closely spaced edges or other high spatial frequency components.

The cropped image generated by the ROI module 556 may then be passed to the text/object/color recognition module 570, which may use conventional optical character recognition techniques to identify text in the cropped image. The text recognized by the text/object/color recognition module 570 may then be passed to a text-to-speech module 556 which may use conventional text-to-speech techniques to translate the recognized text to a speech signal. The system 110 sends the speech signal to the earpiece 202 via the short-range communication interface 524 and the short-range communication transceiver 512.

In addition to recognizing text in the cropped image, the module 570 may further process the cropped image or the entire frame captured by the imager of the camera 112 to identify different colors and/or to identify a dominant color. Information concerning the identified colors may be provided to the user via the text-to-speech module 568 and the short-range communication transceiver interface 512.

Alternatively or in addition, the module 570 may program the processor 522 to recognize the logos and/or product configurations of common objects that may be found in a particular environment such as a grocery store. The module 570 may include, for example, a database containing highly-compressed logo and/or product images where the database is indexed by product features such as color, shape and/or spatial frequency content. Alternatively, the module 570 may include multiple coefficient sets for a neural network, each coefficient set corresponding to a respective use environment (e.g. pharmacy, grocery store, clothing store, museum, etc.) In this example, the module may return text identifying the logo and/or object or an indication that the logo and/or object cannot be identified. As described below, information about logos or product configurations may also be provided by the AI service 406 and/or crowdsource service 412.

As described above, in some embodiments, the VIP may be able to provide gestural or voice commands The example voice commands are received from the earpiece 202 via the short-range communications transceiver 512 and the short-range communications interface 524. These commands are passed to the optional speech recognition model 568 where they are processed into textual commands used by the local text recognition facility or transmitted to the AI provider 406 and/or crowdsource provider 412 via the WLAN transceiver 514. Example voice commands include: “What color is this?”; “Tell me what color this is”; “Is there any writing?”;“What's written here?”; “Is there any text?”; “What's in my hand?”; “What am I holding?” In order to provide maximum flexibility to the user, the system uses a broad entity-based model for query recognition that allows for multiple formulations of a question or command These and other questions may be asked by the user to obtain contextual assistance with an object in the field of view of the camera and indicated by a hand gesture. As described below, a hand gesture may also be used to request specific assistance with respect to an indicated object. For example, each of the voice commands described above may have an equivalent gestural command VIPs may be more comfortable using gestural commands than verbal commands as the gestural commands are more discrete.

The example task assistance system 110 provides information automatically (i.e. without an explicit request) and/or on-demand (e.g. in response to a gestural or verbal command) The system 110 continually tracks the user's hands and interprets the user grasping an object at in the field of view of the camera 112 as a trigger for audio assistance. To conserve battery power, the example system 110 may operate in a low-power mode where only the hand tracking system 114 is active and the remainder of the system is in a sleep state. When a hand is detected in the field of view of the hand tracking system 114, the remainder of the system 110 may be activated.

The example hand tracking system 114 retrieves an indication of the pose of the hand in the image. The provided pose information includes data describing finger-bone positions in space, which the system 110 transforms into the camera's frame of reference. This allows the module 556 to quickly crop out unwanted regions of the image (e.g. out of focus regions outside of the grasp indicated by the pose of the hand). After the regions of the image likely to contain objects have been identified, the module 556 may, for example, run a fast Extremal-Regions Text Detection classifier, which, as described in the above referenced article, identifies image regions likely to contain text. If the example module 556 finds regions that may contain text, the frame or the text-containing portions thereof may be processed by the local text/object/color recognition module 570 or sent to AI system 406 and/or crowdsource system 412 for OCR processing. A pictorial representation of this process is shown in FIG. 3. In this instance, the grasping of the object is a gestural command

As described above, in one embodiment, the hand tracking system 114 includes a Leap Motion sensor. The Leap Motion sensor tracks hands in its field of view and returns hand-pose data indicating the position and orientation of the hands and fingers in space, even if part of the hand is obscured by the held object. Thus, the hand tracking system 114 can return data indicating the positions and orientations of the fingers of the left hand 302 holding the object 304 and/or the fingers of the right hand 310 making the thumbs-up gesture. This data can be interpreted by the gesture recognition module 564 to identify the gesture. The thumbs-up gesture is provided as an example only is contemplated that the system may recognize other gestures such as a pointing gesture, a fist, or an open hand, among others, and translate these gestures into other commands

The thumbs-up gesture may be used in a situation where a VIP wants a detailed description of the held object as the contextual assistance. The VIP may make the “thumbs-up” gesture 310 in front of the camera 112 to send a query to the crowdsource human-labeling service 412 and/or to the AI service 406. The thumbs-up gesture may be advantageous because it can be performed easily with one hand and can be accurately detected from the data provided by the hand tracking system 114.

In response to a verbal or gestural command one embodiment of the task assistance system 110 may send the cropped image 306 or 308 provided by the ROI module 556 or the entire image frame 300 provided by the imager of the camera 112 through the WAN 402 and Internet 410 to the crowdsource system 412. Human operators at the crowdsource system 412 recognize the content in the image may and send a text description back to the task assistance system 110. All images may be compressed prior to network transfer to reduce the transmission latency, for example joint picture experts group (JPEG) compression yields an image size between 20 KB and 100 KB. even with this compression, however, frequent requests for AI and/or crowdsource assistance may use excessive network bandwidth. Thus the system 110 may use several computational techniques to prioritize on-board detection as much as possible. For example, the task assistance system 110 may not automatically send frames to the AI server 406 and/or the crowdsource server 412 because, as described above, there is a significant latency in the responses. In some examples, such a transmission may be triggered via an intentional interaction (e.g. a verbal or gestural command) For text recognition, the system 110 may reduce network communications by predicting the likelihood that the cropped image or image frame contains text, as described above. A user may override this feature by asking a specific question such as “Is there any text?”

In the examples described above, descriptions are verbalized through a discrete earpiece 202. It is contemplated, however, that other transducer devices, such as bone-conducting headphones may be used for a less invasive solution. The text-to-speech module 566 may be customized to the user providing speech in the particular language and dialect most familiar to the user.

To assist the user in positioning the object for processing by the task assistance system 110, the ROI module 556 and or hand tracker API 550 may send a first audio cue (e.g. a single chime) to the earpiece 202 when the hand tracking system 114 detects a hand entering the field of view of the imager frame, and a second, different audio cue (e.g. a double chime) when the hand leaves the imager frame. In this way, the user can quickly assess whether their grasp and framing is correct. Furthermore this feature may allow users to move their empty hands in the field of view to get a sense of the dimensions of the field of view.

As described above, the task assistance system 110 uses multi-threaded processing to concurrently provide contextual assistance from multiple sources. FIG. 6 is a block diagram showing the processing pipeline of an example system 110. The camera provides image input which may be sent to the ROI cropping module 556 as well as to the crowd labeling/AI modules 554/560. These processes may operate in parallel so that the local processing of image text, colors and/or shapes occurs at the same time as the crowd labeling/AI processing. The gesture recognition module 564 provides command data in parallel to both the ROI cropping module 556 and to the crowd labeling/AI modules 554/560. In the example systems, audio input is provided from the short-range communication transceiver 512 to the speech recognition module 568. The example module 568, in turn, provides the speech commands in parallel to the text/objects/color recognition module 570 and the crowd labeling/AI modules 554/560. Output from both the text/objects/color recognition module 570 and the crowd labeling/AI modules 554/560 may be provided in parallel to the text to speech module 566. To mitigate overlapping requests for use of the text is to speech module 566, it may be desirable for each of the modules 554, 560, and 570 to have distinct priorities. In one embodiment, the module 570 may have the highest priority followed by the AI module 554 and the crowdsource module 560.

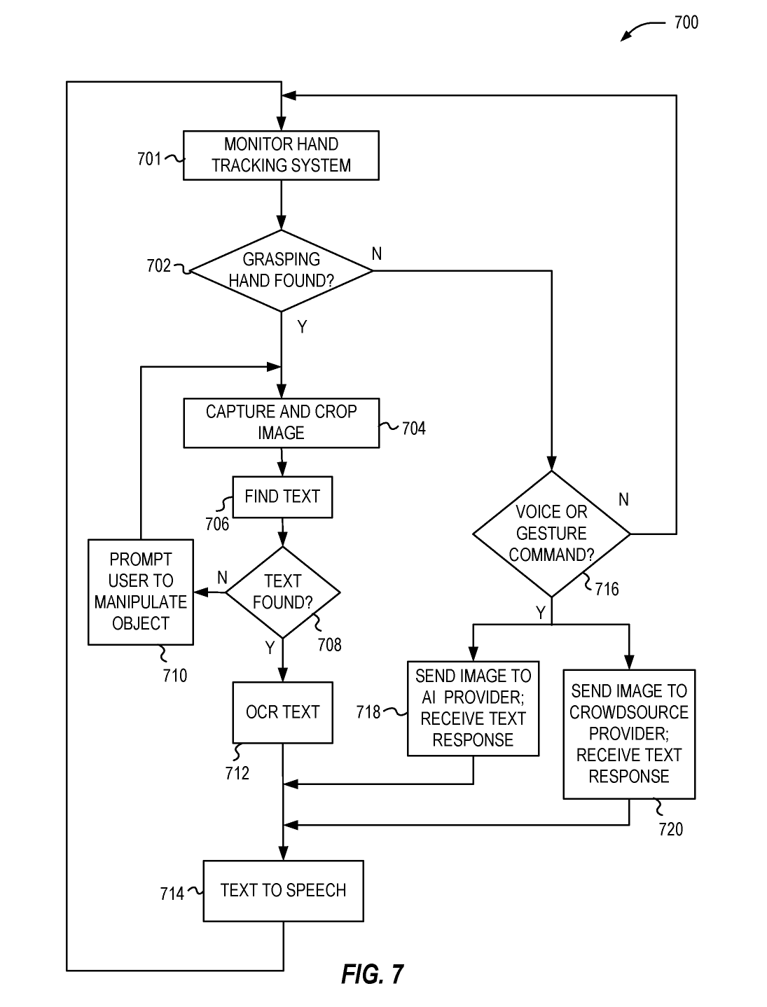

FIG. 7 is a flowchart diagram which illustrates the parallel processing performed by an example task assistance system 110. At block 701, the system 110 is continually monitoring data generated by the hand tracking system 114 for indications of a hand in the field of view of the tracking system 114. When the tracking system 114 finds a hand in the field of view, block 702 applies the data generated by the hand tracking system 114 to the gesture recognition module 564 to determine whether the detected hand pose corresponds to a hand grasping an object. At block 702 when no grasping gesture is found, the system 110 determines at block 716 whether the detected hand pose corresponds to a gestural command If no gestural command is detected at block 716, control returns to block 7012 continue monitoring the hand tracking system 114.

When the example gesture recognition module 564 finds a hand and an object at block 702 the example system 110, using the camera 112 and camera API 562 captures an image of the hand and the object. This image may be passed to the ROI cropping module 556 at block 704. As described above, the example cropping module 556 processes the image to crop out portions of the image that are not likely to include text and/or areas that do not include spatial frequency components indicative of edges. The result is a first level cropped image such as the image 306 shown in FIG. 3. The cropping module 556 may further crop the image to exclude regions that do not include text to obtain a second level cropped image such as image 308 shown in FIG. 3. At block 708 when either no edge like spatial frequency components are found in the captured image or when the spatial frequency components that are found to do not correspond to text, block 710 uses the short-range communications transceiver 512 to send audio instructions to the user to manipulate the object (e.g. to rotate the object) and branches to block 704 to capture and crop a new image of the manipulated object.

When text is found at block 708, the task assistance system 110 extracts the text image and applies it to the text/object/color recognition module 570. Which performs optical character recognition on the text image. The resulting text may then be converted to speech signals at block 714 and the speech signals may be sent to the user via the short-range communication transceiver 512 and the short-range communication earpiece 202.

The portions of FIG. 7 described above concern the local operation of an example task assistance system 110. The system 110 may also send the captured image of the object to an artificial intelligence service 406 and/or a crowdsource service 412 to be recognized. When block 702 indicates that a hand has been found in the field of view of the hand tracking system 114, block 716 processes data provided by the hand tracking system 114 and/or the short-range transceiver 512 for a gestural command or a voice command respectively. The monitoring at block 716 may occur in parallel with the local operation of the task assistance system 110, described above. When block 716 detects a command the system 110 compresses the image using the image/video compression module 558 and sends the image to the AI provider 406 at block 718 and/or to the crowdsource provider 412 at block 720. The user may indicate the particular provider as part of the command, for example, “AI—what is in my hand?” or “crowdsource—what color is this?”. As described above, both the AI provider 406 and the crowdsource provider 412 may return a short text description of the image. At block 714, this text description may be passed to the text-to-speech module 5664 presentation to the user via the earpiece 202.

Although FIG. 7 shows the complete image captured by the imager of the camera 112 being sent to the AI service 406 and/or crowdsource service 412, in other examples, the cropped image (e.g. 306 or 308) provided by the ROI cropping module 556 may be provided instead. Furthermore, while the example shown in FIG. 7 uses the voice and gesture commands only for the external AI and crowdsource services, it is contemplated that these commands may also be used by the local processing. For example in response to the user asking “what color is this?”, the task assistance system 110 may send the cropped image to the text/object/color recognition module 570 with a request for the module to return a list of the detected colors and/or a dominant color in the image.

The text/object/color recognition module 570 may also process image data to identify a product shape and/or product logo. As described above, the example module 570 may be coupled to a database or to a neural network program to identify logos and product configurations for a particular venue such as a grocery store, clothing store etc. The detection of a product configuration or logo may also be in response to a user command.

### EXAMPLE 1

In one example, an apparatus for audibly providing contextual assistance data with respect to objects includes an imager having a field of view; and a processor coupled to the imager and configured to: receive information indicating presence of a hand in the field of view of the imager; responsive to the information indicating the presence of the hand, capture an image from the imager, extract an image of an object indicated by the hand from the captured image; generate the contextual assistance data from the image of the indicated object; and generate audio data corresponding to the generated contextual assistance data.

In another example, the apparatus is further configured to be coupled to one of a belt, a pendant, or an article of clothing.

In yet another example, the apparatus is configured to be positioned such that the imager is configured to capture normal tactile interaction with objects and visual features in the environment.

In another example, the apparatus further includes a hand tracking sensor system, coupled to the processor and having a field of view that overlaps or complements the field of view of the imager. The hand tracking sensor system is configured to provide the processor with the information indicating the presence of the hand in the field of view of the imager and to provide the processor with data describing a pose of the hand.

In yet another example, the processor is further configured to recognize a gesture based on the data describing the pose of the hand, and to generate a command corresponding to the gesture.

In another example, the recognized gesture includes a grasping pose in which the hand in the image is grasping the object and the generated command is arranged to configure the processor to generate, as the contextual assistance data, data identifying the object and to translate the at least one identified property to generate the audio data.

In one example, the imager is a component of a camera, and the camera further including shallow depth of field (DOF) optical elements that provide a DOF of between ten centimeters and two meters.

In another example the processor is configured to: crop the image provided by the imager to provide a cropped image; identify an ROI in the cropped image, the ROI including portions of the cropped image including a textual feature of the object; and extract the portions of the cropped image including the textual feature.

In another example, the at least one feature includes a textual feature of the object and the processor is configured to: perform optical character recognition (OCR) on the extracted portion of the cropped image to generate, as the contextual assistance data, text data corresponding to the textual features; and convert the generated text data to the audio data.

In one example the contextual assistance data with respect to the object includes color information about the object and the processor is further configured to: process the cropped image to identify colors in the cropped image and to generate, as the contextual assistance data, text data including a description of a dominant color or a list of identified colors; and convert the generated text data to the audio data.

In another example, the contextual assistance data with respect to the object includes a description of the object and the apparatus further includes: a wireless local area network (WLAN) communication transceiver; and an interface to a crowdsource service. The processor is configured to: provide at least a portion of the captured image including the object to the crowdsource interface; receive, as the contextual assistance data, text data describing the object from the crowdsource interface; and generate further audio data from the received text data.

In yet another example, the processor is further configured to: identify a region of interest (ROI) in the cropped image, the ROI including portions of the cropped image including textual features of the object; extract the portions of the cropped image including the textual features; and perform optical character recognition (OCR) on the textual features of the object. The processor is configured to provide the cropped image to the crowdsource interface module in parallel with performing OCR on the textual features of the object.

### EXAMPLE 2

In one example, a method for audibly providing contextual assistance data with respect to objects in a field of view of an imager includes: receiving information indicating presence of a hand in the field of view of the imager; responsive to the information indicating the presence of the hand, capturing an image of the hand and of an object indicated by the hand; processing, by the processor, the captured image to generate the contextual assistance data with respect to the indicated object; and generating, by the processor, audio data corresponding to the generated contextual assistance data.

In another example, the capturing of the image of the hand and the object indicated by the hand includes: processing the captured image to recognize a grasping pose of the hand grasping the object; and identifying an object grasped by the hand as the object indicated by the hand.

In another example, the method includes: cropping the image provided by the imager to provide a cropped image; identifying an ROI in the cropped image, the ROI including portions of the cropped image having textual features of the object; and extracting the portions of the cropped image including the textual features.

In yet another example, the method includes: performing optical character recognition (OCR) on the extracted portion of the cropped image to generate, as the contextual assistance data, text data corresponding to the textual features; and converting the generated text data to the audio data.

In one example, the contextual assistance data with respect to the object includes a description of the object and the method further includes: transmitting, by the processor, at least a portion of the captured image including the object to a crowdsource interface with a request to identify the object; receiving, by the processor and as the contextual assistance data, text describing the object from the crowdsource interface; and generating, by the processor, further audio data from the received text, wherein the transmitting, receiving, and generating of the further audio data are performed by the processor in parallel with the processor performing the optical character recognition.

In another example, the method includes: receiving, by the processor, data describing a pose of a further hand in the image; responsive to the data describing the pose of the further hand, recognizing a gesture; and generating a command, corresponding to the recognized gesture, the command being a command to send the cropped image to the crowdsource interface.

### EXAMPLE 3

In one example, a non-transitory computer-readable medium including program instructions, that, when executed by a processor are arranged to configure the processor to audibly identify objects in a field of view of an imager, the program instructions arranged to configure the processor to: receive information indicating presence of a hand indicating an object in the field of view of the imager; responsive to the information indicating the presence of the hand indicating the object, capture an image of the object; process the captured image to generate contextual assistance data with respect to the indicated object; and generate audio data corresponding to the generated contextual assistance data.

In another example, the program instructions arranged to configure the processor to capture the image of the hand and the object indicated by the hand include program instructions arranged to configure the processor to: process the captured image to recognize a grasping pose of the hand grasping the object; and identify an object grasped by the hand as the object indicated by the hand.

In another example, the program instructions are further arranged to configure the processor to: crop the image provided by the imager to provide a cropped image; identify an ROI in the cropped image, the ROI including portions of the cropped image including textual features of the object; and extract the portions of the cropped image including the textual features.

In yet another example, the program instructions are further arranged to configure the processor to: perform optical character recognition (OCR) on the extracted portion of the cropped image to generate, as the contextual assistance data, text data corresponding to the textual features; and convert the generated text data to the audio data.

In one example, the program instructions are further arranged to configure the processor to: transmit at least a portion of the captured image including the object to a crowdsource interface with a request to identify the object; receive, as the contextual assistance data, text describing the object from the crowdsource interface; and generate further audio data from the received text, wherein the program instructions are arranged to configure the processor to transmit, receive, and generate the further audio data in parallel with the instructions arranged to configure the processor to perform the optical character recognition.

In another example, the program instructions are further arranged to configure the processor to: receive data describing a pose of a further hand in the image; responsive to the data describing the pose of the further hand, recognize a gesture; and generate a command, corresponding to the recognized gesture, to send the cropped image to the crowdsource interface.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the scope of the appended claims.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the example illustrated aspects of the claimed subject matter. In this regard, it will also be recognized that the disclosed example embodiments and implementations include a system as well as computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned example systems have been described with respect to interaction among several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it is noted that one or more components may be combined into a single component providing aggregate functionality or divided into several separate sub-components, and any one or more middle layers, such as a management layer, may be provided to communicatively couple to such sub-components in order to provide integrated functionality Any components described herein may also interact with one or more other components not specifically described herein but generally known by those of skill in the art.

Furthermore, while a particular feature of the claimed subject matter may have been disclosed with respect to one of several implementations, such feature may be combined with one or more other features of the other implementations as may be desired and advantageous for any given or particular application. In addition, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. An apparatus for audibly providing contextual assistance data with respect to objects comprising:
an imager having a field of view; and
a processor coupled to the imager and configured to:
receive information indicating presence of a hand in the field of view of the imager;
responsive to the information indicating the presence of the hand, capture an image from the imager,
extract an image of an object indicated by the hand from the captured image;
generate the contextual assistance data from the image of the indicated object; and
generate audio data corresponding to the generated contextual assistance data.

2. The apparatus of claim 1, wherein the apparatus is configured to be coupled to one of a belt, a pendant, or an article of clothing.

3. The apparatus of claim 2, wherein the apparatus is configured to be positioned such that the imager is configured to capture normal tactile interaction with objects and visual features in the environment.

4. The apparatus of claim 1, further comprising a hand tracking sensor system, coupled to the processor and having a field of view that overlaps or complements the field of view of the imager, the hand tracking sensor system being configured to provide the processor with the information indicating the presence of the hand in the field of view of the imager and to provide the processor with data describing a pose of the hand wherein the processor is further configured to recognize a gesture based on the data describing the pose of the hand, and to generate a command corresponding to the gesture.

5. The apparatus of claim 4, wherein the recognized gesture includes a grasping pose in which the hand in the image is grasping the object and the generated command is arranged to configure the processor to generate, as the contextual assistance data, data identifying at least one property of the object.

6. The apparatus of claim 1, wherein the imager is a component of a camera, the camera further including shallow depth of field (DOF) optical elements that are configured to provide a DOF of between ten centimeters and two meters.

7. The apparatus of claim 1, wherein the processor is further configured to:
crop the image provided by the imager to provide a cropped image;
identify an ROI in the cropped image, the ROI including portions of the cropped image including a textual feature of the object;
extract the portions of the cropped image including the textual feature;
perform optical character recognition (OCR) on the extracted portion of the cropped image to generate, as the contextual assistance data, text data corresponding to the textual feature; and
convert the generated text data to the audio data.

8. The apparatus of claim 7, wherein the contextual assistance data with respect to the object includes color information about the object and the processor is further configured to:
process the cropped image to identify colors in the cropped image and to generate, as the contextual assistance data, text data including a description of a dominant color or a list of identified colors; and
convert the generated text data to the audio data.

9. The apparatus of claim 1, wherein the contextual assistance data with respect to the object includes a description of the object and the apparatus further comprises:
a wireless local area network (WLAN) communication transceiver;
and an interface to a crowdsource service;
wherein the processor is configured to:
provide at least a portion of the captured image including the object to the crowdsource interface;
receive, as the contextual assistance data, text data describing the object from the crowdsource interface; and
generate further audio data from the received text data.

10. The apparatus of claim 9, wherein the processor is further configured to:
identify a region of interest (ROI) in the cropped image, the ROI including portions of the cropped image including textual features of the object;
extract the portions of the cropped image including the textual features; and
perform optical character recognition (OCR) on the textual features of the object;
wherein the processor is configured to provide the cropped image to the crowdsource interface module in parallel with performing OCR on the textual features of the object.

11. A method for audibly providing contextual assistance data with respect to objects in a field of view of an imager, the method comprising:
receiving, by a processor, information indicating presence of a hand in the field of view of the imager;
responsive to the information indicating the presence of the hand, capturing an image of the hand and of an object indicated by the hand;
processing, by the processor, the captured image to identify a gesture of the hand and, based on the identified gesture to generate the contextual assistance data with respect to the indicated object; and
generating, by the processor, audio data corresponding to the generated contextual assistance data.

12. The method of claim 11, wherein the capturing of the image of the hand and the object indicated by the hand includes:
processing the captured image to identify a grasping pose of the hand grasping the object as the gesture; and
identifying an object grasped by the hand as the object indicated by the hand.

13. The method of claim 11, further comprising:
cropping the image provided by the imager to provide a cropped image;
identifying an ROI in the cropped image, the ROI including portions of the cropped image having textual features of the object;
extracting the portions of the cropped image including the textual features
performing optical character recognition (OCR) on the extracted portion of the cropped image to generate, as the contextual assistance data, text data corresponding to the textual features; and
converting the generated text data to the audio data.

14. The method of claim 13, wherein the contextual assistance data with respect the object includes a description of the object and the method further comprises:
transmitting, by the processor, at least a portion of the captured image including the object to a crowdsource interface with a request to identify the object;
receiving, by the processor and as the contextual assistance data, text describing the object from the crowdsource interface; and
generating, by the processor, further audio data from the received text, wherein the transmitting, receiving, and generating of the further audio data are performed by the processor in parallel with the processor performing the optical character recognition.

15. The method of claim 11, further comprising:
receiving, by the processor, data describing a pose of the hand in the image;
responsive to the data describing the pose of the further hand, identifying the gesture; and
generating a command, corresponding to the identified gesture, the command being a command to send the cropped image to the crowdsource interface.

16. A non-transitory computer-readable medium including program instructions, that, when executed by a processor are arranged to configure the processor to audibly provide contextual assistance data with respect to objects in a field of view of an imager, the program instructions being arranged to configure the processor to:
receive information indicating presence of a hand indicating an object in the field of view of the imager;
responsive to the information indicating the presence of the hand indicating the object, capture an image of the object;
process the captured image to generate the contextual assistance data with respect to the indicated object; and
generate audio data corresponding to the generated contextual assistance data.

17. The non-transitory computer readable medium of claim 16, wherein the program instructions arranged to configure the processor to capture the image of the hand and the object indicated by the hand include program instructions arranged to configure the processor to:
process the captured image to recognize a grasping pose of the hand grasping the object; and
identify an object grasped by the hand as the object indicated by the hand.

18. The non-transitory computer readable medium of claim 16, wherein the program instructions are further arranged to configure the processor to:
crop the image provided by the imager to provide a cropped image;
identify an ROI in the cropped image, the ROI including portions of the cropped image including textual features of the object;
extract the portions of the cropped image including the textual features.
perform optical character recognition (OCR) on the extracted portion of the cropped image to generate, as the contextual assistance data, text data corresponding to the textual features; and
convert the generated text data to the audio data.

19. The non-transitory computer readable medium of claim 18, wherein the program instructions are further arranged to configure the processor to:
transmit at least a portion of the captured image including the object to a crowdsource interface with a request to identify the object;
receive, as the contextual assistance data, text describing the object from the crowdsource interface; and
generate further audio data from the received text, wherein the program instructions are arranged to configure the processor to transmit, receive, and generate the further audio data in parallel with the instructions arranged to configure the processor to perform the optical character recognition.

20. The non-transitory computer readable medium of claim 19, wherein the program instructions are further arranged to configure the processor to:
receive data describing a pose of a further hand in the image;
responsive to the data describing the pose of the further hand, recognize a gesture; and
generate a command, corresponding to the recognized gesture, to send the cropped image to the crowdsource interface.
